(19) United States
(12) Patent Application Publication
(10) Pub. No.: US 2006/0292407 A1
(43) Pub. Date: Dec. 28, 2006

(54) Microfluidic fuel cell system and method for portable energy applications

(76) Inventors: Dominic Gervasio, Fountain Hills, AZ (US); Frederic Zenhausern, Fountain Hills, AZ (US)

Correspondence Address: NEEDLE & ROSENBERG, P.C., SUITE 1000, 999 PEACHTREE STREET, ATLANTA, GA, 30309-3915, US

(21) Appl. No.: 11/304,984

(22) Filed: Dec. 15, 2005

Related U.S. Application Data
(60) Provisional application No. 60/636,211, filed on Dec. 15, 2004.

(51) Int. Cl. H01M 8/06; H01M 8/10; H01M 2/08

(52) U.S. Cl. 429/19; 429/30; 429/35

(57) ABSTRACT

A system and method for generating and separating gaseous fuel components, as well as the partitioning of liquid and gaseous byproducts, in the operation of a portable fuel cell device comprises: a microfluidic containment volume (140, 230); a substrate for supporting a catalytic composition (150, 215, 315) that is suitably adapted to promote hydrolysis of a substantially liquid-borne fuel precursor (330) to generate a gaseous fuel component; a liquid/gas separator (155, 220, 363) for at least partially partitioning a gaseous component from a liquid component; a fuel cell (210, 310) comprising an anode (125) and a cathode (135); and electrical connections coupled thereto to power a load (120). Various features and parameters of the present invention may be suitably adapted to optimize the gas/liquid transport and/or partition functions for any specific fuel cell design. The present invention provides improved control of the rate of delivery/removal of gaseous components to/from a fuel cell fuel solution in addition to improved application of fuel cell technology to power inter alia portable electronic devices.

### CROSS REFERENCE TO RELATED APPLICATIONS

This application claims priority to U.S. provisional patent application Ser. No. 60/636,211 filed in the United State Patent and Trademark Office on Dec. 15, 2004, the disclosure of which is hereby incorporated by reference in its entirety for all purposes. This application also claims priority to International PCT Patent Application No.: PCT/US2004/03865 filed Nov. 15, 2004, which claims priority to U.S. provisional patent application Ser. No. 60/519,993 filed in the United States Patent and Trademark Office on Nov. 14, 2003, both disclosures of which are also hereby incorporated by reference in their entirety for all purposes

### GRANT FUNDING

National Science Foundation; Connection One 003576; Grant No. 021759-006; Org. No. E0101.

### FIELD OF INVENTION

The present invention generally concerns fuel cell technology. More particularly, the present invention involves a system and method for the storage, generation and separation of gaseous fuel components as well as the partitioning of liquid and gaseous byproducts in the operation of a portable fuel cell device.

### BACKGROUND OF THE INVENTION

Fuel cells are electrochemical cells in which a free energy change resulting from a fuel oxidation is converted into electrical energy. The earliest fuel cells were first constructed by William Grove in 1829 with later development efforts resuming in the late 1930's with the work of F. T. Bacon. In early experiments, hydrogen and oxygen gas were bubbled into compartments containing water that were connected by a gas barrier through which an aqueous electrolyte was permitted to pass. When composite graphite/platinum electrodes were submerged into each compartment and the electrodes were conductively coupled, a complete circuit was formed and redox reactions took place in the cell: hydrogen gas was oxidized to produce protons at the anode (i.e., “hydrogen electrode”) and electrons were liberated to flow to the cathode (i.e., “oxygen electrode”) where they subsequently combined with oxygen.

Since that time, interest in the development of viable commercial and consumer-level fuel cell technology has been renewed. In addition to various other benefits of conventional methods, fuel cells generally promise improved power production with higher energy densities. For example, a typical hydrogen-oxygen cell operating at about 250° C. and a pressure of about 50 atmospheres yields approximately 1 volt of electric potential with the generation of water and a small quantity of thermal energy as byproducts. More recently, however, modern Polymer Electrolyte Membrane Fuel Cells (PEMFC's) operating at much lower temperatures and pressures (e.g., on the order of about 80° C. and about 1.3 atmospheres) have been observed to produce nearly the same cell voltage.

An additional advantage of fuel cells is that they generally have a higher energy density and are intrinsically more efficient than methods involving indirect energy conversion. In fact, fuel cell efficiencies have been typically measured at nearly twice those of thermoelectric conversion methods (e.g., fossil fuel combustion heat exchange).

With respect to portable power supply applications, fuel cells function similar different principles and are compared with standard batteries. As a standard battery operates, various chemical components of the electrodes inside the battery package are depleted over time. In a fuel cell, however, as long as fuel and oxidant are continuously supplied to the fuel cell electrodes, the cell's electrode material is not consumed and therefore will not run down or require recharging or replacement.

One class of fuel cells currently under development for general consumer use is that of hydrogen fuel cells, wherein hydrogen-rich compounds are used to fuel the redox reaction. As chemical fuel species are oxidized at the anode, electrons are liberated to flow through the external circuit. The remaining positively-charged ions then move through the electrolyte toward the cathode where they are subsequently bind to oxygen reduced at the cathode. As a result, the free electrons combine with protons and oxygen to produce water—an environmentally clean byproduct.

Prior art fuel cells have typically employed methods to eliminate byproduct gases that generally involve substantially direct gravity-dependent venting to the atmosphere or retention within the fuel cell itself. While these approaches may be acceptable in certain large-scale systems, the broader application of fuel cell technology, for example to portable consumer-level devices, presents previously unresolved problems with respect to the processing of supplied fuels, liquid waste and product gases. Accordingly, a limitation of prior art fuel cell technology concerns the effective and efficient generation and separation of gaseous fuel components as well as the partitioning of liquid and gaseous byproducts during the operation of a fuel cell device.

### SUMMARY OF THE INVENTION

A representative advantage of the present invention includes the user- or designer-controlled processing and/or partitioning of gases produced during operation of a fuel cell device. Another exemplary advantage includes the ability to operate a fuel cell in generally any orientation to vent gaseous byproducts while substantially retaining the fluid solution without significant leakage or fluid migration therefrom.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being had to the accompanying drawings forming a part hereof, wherein like numerals refer to like parts throughout. Other elements, operational features, applications and/or advantages will become apparent in light of certain exemplary embodiments recited in the detailed description, wherein:

FIG. 1 representatively illustrates a block diagram of a gaseous fuel generator and fuel cell subsystem in accordance with an exemplary embodiment of the present invention.

FIG. 2 representatively illustrates a schematic diagram of an integrated microfluidic gaseous fuel generator and fuel cell subsystem in accordance with another exemplary embodiment of the present invention.

FIG. 3 representatively illustrates a schematic diagram of an integrated microfluidic H₂ generator and fuel cell subsystem in accordance with another exemplary embodiment of the present invention.

FIG. 4 illustrates a schematic diagram of an integrated fuel cell system in accordance with an exemplary aspect of the present invention.

FIG. 5 illustrates a pair of exemplary fuel cell housing plates according to one aspect of the present invention.

FIG. 6 illustrates a schematic diagram of an integrated fuel cell system in accordance with an exemplary aspect of the present invention.

FIG. 7 illustrates an exemplary hydrogen generating micro-reactor according to one aspect of the present invention.

FIG. 8 illustrates the exemplary hydrogen generating micro-reactor of FIG. 7 integrated with an exemplary liquid gas separator membrane in a stacked arrangement.

FIG. 9(a) illustrates a schematic diagram of an exemplary piezo pump according to one aspect of the present invention.

FIG. 9(b) illustrates exemplary piezo pump components in both an assembled and unassembled configuration.

FIG. 10 is a graphic illustration of exemplary flow rates achieved by exemplary piezo pumps according to one aspect of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms ‘front’, ‘back’, ‘top’, ‘bottom’, ‘over’, ‘under’, and the like in the Description and/or in the claims, if any, are generally employed for descriptive purposes and not necessarily for comprehensively describing exclusive relative position. It will therefore be understood that any of the preceding terms so used may be interchanged under appropriate circumstances such that various embodiments of the invention described herein, for example, are capable of operation in other configurations and/or orientations than those explicitly illustrated or otherwise described.

### DETAILED DESCRIPTION OF EXEMPLARY EMBODIMENTS

The following descriptions are of exemplary embodiments of the invention and the inventors' conception of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Various representative implementations of the present invention may be applied to any system for controlling or otherwise parameterizing the transport and/or distribution of gases in a fuel cell system. Certain representative implementations may include, for example: controlling the concentration of dissolved gases in a fuel cell solution; controlling the concentration of gaseous phase chemical species in a fuel cell; or controlling the rate of effusion of exhaust gases from a fuel cell. As used herein, the terms “exhaust”, “vent”, “transport”, “diffuse”, “effuse” and “partition”, or any variation or combination thereof, are generally intended to include anything that may be regarded as at least being susceptible to characterization as or generally referring to the movement of at least one chemical compound from one area to another area so as to: (1) relatively decrease the concentration in or around one area, and/or (2) relatively increase the concentration in or around another area. The same shall properly be regarded as within the scope and ambit of the present invention. As used herein, the terms “fuel”, “fluid”, “solution”, “stream”, “liquid” and “effluent”, or any variation or combination thereof, are generally intended to include any anode fuel solution and/or cathode oxidant solution whether or not the solution has been pre-conditioned or post-conditioned with respect to exposure to a fuel cell's electrode elements.

A detailed description of an exemplary application, namely the parameterization and control of the rate of generation of hydrogen from a PEM fuel cell fuel stream, is provided as a specific enabling disclosure that may be generalized to any application of the disclosed system and method for controlling gas transport in any type of fuel cell in accordance with various embodiments of the present invention. Moreover, it will be appreciated that the principles of the present invention may be employed to ascertain and/or realize any number of other benefits associated with controlling the transport of gases in a fuel cell such as, but not limited to: reclamation of gaseous byproducts; reformation of at least one constituent fuel compound; controlling the concentration of dissolved gaseous components and byproducts in a fuel system; controlling a fuel cell's redox reaction kinetics and the like.

Fuel Cells

In the broadest sense, a fuel cell may be generally characterized as any device capable of converting the chemical energy of a supplied fuel directly into electrical energy by electrochemical reactions. This energy conversion corresponds to a free energy change resulting from the oxidation of a supplied fuel (e.g., hydrogen) and the simultaneous reduction of an oxidant (e.g., oxygen). A typical prior art fuel cell consists of an anode (e.g., ‘fuel electrode’) that provides a reaction site to oxidize fuel (e.g., hydrogen) and generate electrons and spent fuel (e.g., protons) and a cathode (e.g., ‘oxidant electrode’) that provides sites to receive the free electrons to reduce an oxidant (e.g., oxygen) which can combine with portions of the spent fuel ions (e.g., protons) in order to produce a potential difference (voltage or electromotive force, emf) across the external circuit. The electrodes are generally gas porous, ionic and electronic conductors that include catalytic properties to provide significant redox reaction rates. At the anode, incident hydrogen gas catalytically ionizes to produce protons (e.g., electron-deficient hydrogen nuclei) and electrons. At the cathode, incident oxygen gas catalytically reacts with incoming electrons from the external circuit to form electron-rich oxygen atoms which combine with protons migrating through the electrolyte to produce water as a byproduct. Depending on various operational parameters of the fuel cell, byproduct water may remain in the electrolyte, thereby increasing the volume and diluting the electrolyte, or may be discharged from the cathode as vapor.

The anode and cathode are generally separated by an ion-conducting electrolytic medium (i.e., PEM's or alkali metal hydroxides such as, for example: KOH, NaOH and the like). In early fuel cell experiments, hydrogen and oxygen were introduced into compartments and respectively while the electrodes where conductively coupled by an external circuit to power a load where electrical work could be accomplished. In the external circuit, electric current is generally transported by the flow of electrons, whereas in the electrolyte, current is generally transported by the flow of ions. In theory, any chemical substance capable of oxidation (i.e., hydrogen, methanol, ammonia, hydrazine, simple hydrocarbons, and the like) which may be supplied substantially continuously may be used as galvanically oxidizable fuel at the anode. Similarly, the oxidant (i.e., oxygen, ambient air, etc.) may be selected to be any substance that can spontaneously oxidize fuel at a sufficient rate to maintain a suitable voltage across the external circuit.

Thermodynamics

The free energy of reaction ΔG of a fuel cell is given as ΔG=ΔE+ΔH, where ΔE is the energy available to accomplish electrical work and ΔH is the energy liberated from the reaction to raise the temperature of the fuel cell and the surroundings. In typical fuel cell applications, the heat liberated to the fuel cell's surroundings is much less than the energy available to accomplish electrical work; which may be expressed as: ΔH [symbol] ΔE.

For example, where

$${Q}_{FuelCell} = \frac{{E}_{Electrical}}{{E}_{Chemical}}$$

represents the efficiency of converting chemical potential energy E_{Chemical} directly to electrical energy E_{Electrical}, typical hydrogen/oxygen fuel cell efficiencies on the order of Q_{FuelCell}=0.65 to about Q_{FuelCell}=0.80 have been observed. These values are nearly twice those of indirect heat-exchange power conversion methods, which may be expressed by the following relation:
Q_{FuelCell}≅2Q_{HeatExchange}

where the heat-exchange efficiency is given as

$${Q}_{HeatExchange} = \frac{{E}_{Combustion}}{{E}_{Chemical}} \times \frac{{E}_{Electrical}}{{E}_{Combustion}}$$

The factor

$$\frac{{E}_{Combustion}}{{E}_{Chemical}}$$

represents the component efficiency of converting chemical potential energy into heat (i.e., the combustion of fossil fuels) and

$$\frac{{E}_{Electrical}}{{E}_{Combustion}}$$

represents the component efficiency of converting heat into electrical energy; for example, steam-driven turbo-electric power.

Accordingly, fuel cell operation is intrinsically more efficient than methods employing heat-exchange power conversion. Moreover, other representative benefits of fuel cells include higher energy densities, quiet and environmentally clean operation and the lack of recharging and/or electrode replacement requirements.

Portable Power Supplies

Standard batteries have generally dominated the available choices for portable power storage solutions for consumer-level electronic equipment in the past. Some of the disadvantages associated with standard batteries, however, is that they generally provide power for a relatively short duration of time and thereafter require recharging or replacement. Fuel cells, on the other hand, have many of the consumer-oriented features typically associated with standard batteries (i.e., providing quiet power in a convenient and portable package) in addition to other representative advantages including, for example, long usage lifetimes and the ability to be fueled with high-energy-density liquid or gaseous compounds rather than the relatively low-energy-density ‘solid fuels’ as are typically used in conventional batteries.

While the size of fuel cells has decreased and their energy densities have increased over time, there have been various problems in the prior art with adaptation of fuel cell technology to applications for delivering power, for example, to portable electronic devices. At least one such problem involves the generation and/or processing of component gases used in a fuel cell.

Fuel Cell Development

One class of fuel cells currently under development for consumer use is the hydrogen fuel cell, wherein hydrogen-rich fuels (i.e., hydrogen, methanol, methane, etc.) are used to fuel the redox reaction. As fuel is oxidized at the anode, protons pass through the cell for reduction at the cathode. In the case of using hydrogen as the fuel for example, proton is formed as a byproduct at the anode. Free electrons from the external circuit then effect reduction of oxygen at the cathode. The reduced oxygen then combines with protons to produce water.

One process for fueling a hydrogen cell comprises that of ‘direct oxidation’ methods. Direct oxidation fuel cells generally include fuel cells in which an organic fuel is fed to the anode for oxidation without significant pre-conditioning or modification of the fuel. This is generally not the case with ‘indirect oxidation’ (e.g., “reformer”) fuel cells, wherein the organic fuel is generally catalytically reformed or processed into organic-free hydrogen for subsequent oxidation. Exemplary prior art direct and indirect fuel cells have been previously disclosed and may be compared, for example, in U.S. Pat. Nos. 3,013,908; 3,113,049; 4,262,063; 4,407,905; 4,390,603; 4,612,261; 4,478,917; 4,537,840; 4,562,123; 4,629,664 and 5,599,638.

Another well-known type of fuel cell component is known as a ‘membrane-electrode assembly’ (MEA), as described for example in U.S. Pat. No. 5,272,017 issuing on Dec. 21, 1993 to Swathirajan. In practice, a number of these unit fuel cells may be stacked or grouped together to form a ‘fuel cell stack’. The individual cells may be electrically connected in series by abutting the anode current collector of one cell with the cathode current collector of a neighboring unit cell in the stack.

Typically, the current produced is proportional to the net reaction rate, wherein one ampere corresponds approximately to 1.04E18 reactions per second. As water saturated H₂ is oxidized at the anode, electrons are liberated to flow through an external circuit to power a load where electrical work may be accomplished. Protons migrate through the proton-transmissive electrolytic membrane where they subsequently are combined with oxygen that has been reduced with incoming electrons from the external circuit with water formed as a result.

Controlling Gas Transport

Given a thin barrier of infinite permeability and cross-sectional area A that extends from x to x+l (where l represents the thickness of the barrier), the volume of the barrier may be expressed as V=Al. Let the concentration at point x of gas G be [G] at time t. Accordingly, the number of gas particles that enter the barrier per unit time is JA where J is the particle flux. Therefore, the rate of increase in molar concentration inside the barrier due to the incoming particle flux is

$$\frac{\partial [ G ]}{\partial t} {\vert}_{x} = \frac{J A}{A l} = \frac{J}{l} .$$

Consider also an out-bound flux of gas particles at the x+l surface of the barrier, which may be similarly derived as

$$\frac{\partial [ G ]}{\partial t} {\vert}_{x + l} = \frac{{J}^{′} A}{A l} = \frac{{J}^{′}}{l} .$$

Therefore, the net time rated change of concentration (e.g., the ‘concentration velocity’) may be expressed as:

$$\frac{ⅆ [ G ]}{ⅆ t} = \frac{J - {J}^{′}}{l}$$

Suppose: (1) that the flux of particles J diffusing inside the barrier comprises motion in response to a thermodynamic force F arising from a concentration gradient; (2) that the particles reach a steady-state drift speed s when the thermodynamic force F is matched by the viscous drag; (3) that the drift speed s is proportional to the thermodynamic force F; (4) that the particle flux J is proportional to the drift speed; and (5) that the thermodynamic force F is proportional to the spatial concentration gradient

$$\frac{ⅆ [ G ]}{ⅆ x} .$$

The resulting chain of proportionalities

$$J ∝ s , s ∝ F , and F ∝ \frac{ⅆ [ G ]}{ⅆ x}$$

implies that the particle flux J is proportional to the concentration gradient

$$\frac{ⅆ [ G ]}{ⅆ x} ,$$

which will be apparent as corresponding to ‘Fick's First Law of Diffusion’. The constant of proportionality is given as the diffusion coefficient D in the equation

$$J = D \frac{ⅆ [ G ]}{ⅆ x}$$

for diffusion restricted to a single dimension x. Therefore, the expression J-J′ taken from the expression for the diffusive concentration velocity becomes

$$D \frac{ⅆ {[ G ]}^{′}}{ⅆ x} - D \frac{ⅆ [ G ]}{ⅆ x} .$$

Substitution of the linear accumulation of particle concentration over the thickness of the membrane yields

$$J - {J}^{′} = D \frac{ⅆ}{ⅆ x} ( [ G ] + \frac{ⅆ [ G ]}{ⅆ x} l ) - D \frac{ⅆ [ G ]}{ⅆ x}$$

which further reduces to

$$J - {J}^{′} = D l \frac{{ⅆ}^{2} [ G ]}{ⅆ {x}^{2}} .$$

This expression may then be substituted back into the concentration velocity expression to give:

$$\frac{ⅆ [ G ]}{ⅆ t} = \frac{J - {J}^{′}}{l} = D \frac{{ⅆ}^{2} [ G ]}{ⅆ {x}^{2}} = D {∇}_{x}^{2} [ G ]$$

which is the time dependent diffusion equation according to ‘Fick's Second Law of Diffusion’ and relates the concentration velocity at any point to the spatial variation of the concentration at that point. More generally, this may be appreciated as a physical basis for the typically observed behavior of diffusing chemical species translating away from areas of relative high concentration to areas of relative lower concentration (e.g., “moving down the concentration gradient”).

Next, consider the time dependence of the partial molecular pressure p of an effusing gas G from a container of given volume V. The ‘Ideal Gas Law’ PV=nRT, which for molecular-scale systems rather than for large aggregates of particles (i.e., moles of molecules), becomes pV=nkT

wherein:

p is the partial molecular pressure;
V is the volume of the container providing spatial boundary conditions;
n is the number of particles;
k is the Boltzmann constant; and
T is the temperature.

Solving for the partial pressure yields

$$p = \frac{n k T}{V} .$$

After taking the partial derivative with respect to time at constant temperature and volume, the following expression for the pressure velocity may be obtained:

$${\frac{\partial p}{\partial t} )}_{T , V} = \frac{\partial ( \frac{n k T}{V} )}{\partial t} = \frac{k T}{V} \frac{\partial n}{\partial t}$$

For an effusing gas that is not replenished over time as the gas escapes, the time-rated change of the number of particles is given as

$$\frac{\partial n}{\partial t} = - {Z}_{w} {A}_{o} ,$$

where Z_{w} is the collisional frequency associated with the mean free path of the gas particles and Aₒ is the area of the opening that the effused gas has available to escape from. The collisional frequency is related to the partial pressure of the gas p, the mass of the gas m and the temperature of the system T by the equation

$${Z}_{w} = \frac{p}{\sqrt{2 π m k T}} .$$

Substitution of this relation back into the expression for the pressure velocity yields

$$\frac{\partial p}{\partial t} = \frac{- p {A}_{0}}{V} \sqrt{\frac{k T}{2 π m}}$$

which integrates over time to

$$p = {p}_{0} {ⅇ}^{\frac{- t}{τ}} ,$$

where

$$τ = \frac{V}{{A}_{0}} \sqrt{\frac{2 π m}{k t}} .$$

From this expression for the effusive pressure velocity, the following may generally be observed: (1) if the gas is not replenished, the pressure decreases exponentially to zero; (2) the pressure velocity is faster with increasing temperature and slower with decreasing temperature; (3) the pressure velocity is slower with heavier particles and faster with less massive particles; (4) the pressure velocity is faster with increasing surface area of the effusive opening(s) and slower with decreased surface area; and (5) the pressure velocity is slower with increasing volume of the effusive container and faster with increasing volume.

At constant temperature, the time derivative of the expression for the partial

$${pressure p = \frac{n k T}{V} becomes \text{:} \\ \frac{\partial p}{\partial t} )}_{T} = k T \frac{\partial ( \frac{n}{V} )}{\partial t} = k T \frac{\partial [ G ]}{\partial t}$$

Therefore, substituting the expression corresponding to Fick's Second Law of Diffusion for the concentration velocity previously derived, the generalized expression for the pressure velocity of a gas diffusing in three dimensions in a barrier of infinite permeability as a function of concentration of the gas [G] may be represented as:

$${\frac{ⅆ p}{ⅆ t} )}_{T} = - k T {D}_{G} {∇}^{2} [ G ] = - k T {D}_{G} ( \frac{{\partial }^{2}}{\partial {x}^{2}} + \frac{{\partial }^{2}}{\partial {y}^{2}} + \frac{{\partial }^{2}}{\partial {z}^{2}} ) [ G ]$$

If, however, the barrier is assumed to have finite diffusive permeability, an additional diffusion coefficient \hat{D}_{Ψ(a,b,c . . . )} may be included to account for various barrier-dependent permeability metrics such as, for example: non-uniform porosity; anisotropic transport along different dimensions; hydrophobicity; barrier/membrane/capillary defects; etc.

As enabling disclosure for a representative embodiment directed to an exemplary NaBH₄ fuel cell system in accordance with one aspect of the present invention is developed, it will be convenient to consider the expression for H₂ diffusing through a membrane (or otherwise porous barrier)

$${Ψ \text{:} \frac{ⅆ p}{ⅆ t} )}_{Ψ , {H}_{2}}^{diffusion} = - k T ( {\hat{D}}_{Ψ ( a , b , c… )} {D}_{{H}_{2}} ) ( \frac{{\partial }^{2}}{\partial {x}^{2}} + \frac{{\partial }^{2}}{\partial {y}^{2}} + \frac{{\partial }^{2}}{\partial {z}^{2}} ) [ {H}_{2} ]$$

Upon inspection, this expression relates the concentration of hydrogen at any point within a membrane (or otherwise porous barrier) Ψ to the three dimensional variation of hydrogen concentration at that point; which is to say that hydrogen will diffuse through a porous barrier so as to move down its concentration gradient from volume elements comprising higher H₂ concentration to volume elements comprising relative lower H₂ concentration.

Substitution of A_{Ψ}l for the volume V in the effusion equation

$$\frac{ⅆ p}{ⅆ t} = \frac{- p {A}_{0}}{V} \sqrt{\frac{k T}{2 π m}} yields \frac{ⅆ p}{ⅆ t} = \frac{- p {A}_{0}}{{A}_{Ψ} l} \sqrt{\frac{k T}{2 π m}} .$$

If the ratio of the area of the membrane openings to the aggregate surface area of the membrane normal to the effusing particle transport path is taken to be a dimensionless quantity θ corresponding to the porosity of the membrane at the surface of effusion, a composite expression for hydrogen effusing from a membrane (or otherwise porous barrier) surface becomes:

$${\frac{ⅆ p}{ⅆ t} )}_{Ψ , {H}_{2}}^{effusion} = - {p}_{{H}_{2}} {θ}_{Ψ} \sqrt{\frac{k T}{2 π {m}_{{H}_{2}} {l}_{Ψ}^{2}}}$$

and relates the vapor pressure of carbon dioxide that diffuses through the barrier to reach the exterior surface of the porous barrier Ψ to: the back-side pressure of hydrogen p_{H}_{₂}; the temperature T; the mass of hydrogen m_{H}_{₂}; the thickness of the barrier l; and the porosity of the barrier θ_{Ψ}. Accordingly, hydrogen will generally: (1) effuse more rapidly at higher operating temperatures and more slowly at lower temperatures; (2) effuse more rapidly with increased back-side pressure of H₂ and more slowly with decreased back-side pressure; (3) effuse more rapidly with membranes having increased porosity and more slowly with decreased porosity; and (4) effuse more rapidly with porous barriers having decreased linear transport distances (e.g., thinner membranes) and more slowly with increased transport distances.

Borohydride Fuel Cell System for Portable Applications

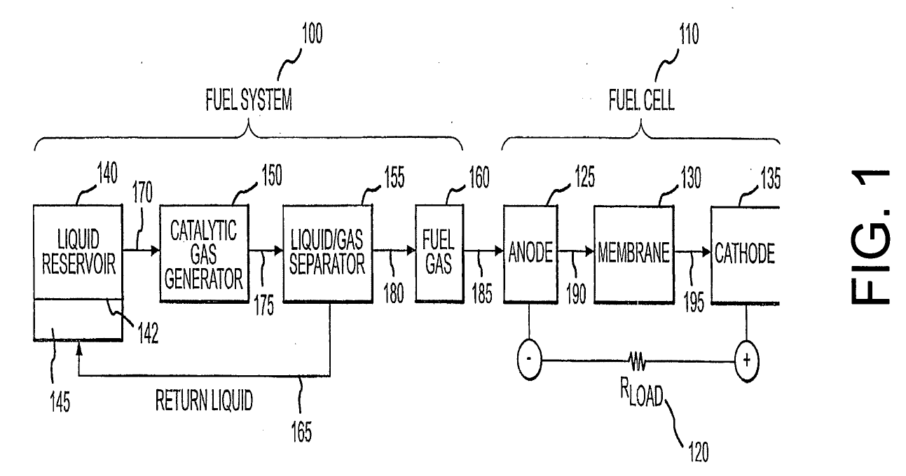

FIG. 1 generally depicts a borohydride-based fuel cell system 100 in accordance with an exemplary embodiment of the present invention. Fuel cell 110 generally comprises cathode 135, electrolytic membrane 130 and anode 125. Ions generally flow to/from anode 125 via anode/electrolytic membrane fuel transport path 190 across membrane 130 from/to cathode 135 via electrolytic membrane/cathode fuel transport path 195. An electrical load 120 may be bridged across anode 125 and cathode 135 in order to accomplish electrical work.

Fuel system 100 generally comprises liquid fuel reservoir 140, catalytic gas generator 150, liquid/gas separator 155 and fuel gas 160. As fuel exits reservoir 140 and is introduced to catalytic gas generator 150 via fuel transport path 170, fuel gas 160 is generated. The mixture of liquid and gaseous fuel is then introduced to liquid/gas separator 155 via transport path 175. Upon separation of the liquid fuel from gaseous fuel, liquid fuel is returned to reservoir 140 via return liquid transport path 165 with gaseous fuel 160 exiting 180 the liquid/gas separator for subsequent introduction 185 to the anode 125 of fuel cell 110.

Fuel reservoir 140 may be optionally configured with a diaphragm or bladder 142 for disposing processed liquid fuel in a region 145 at least partially separated from unprocessed liquid fuel.

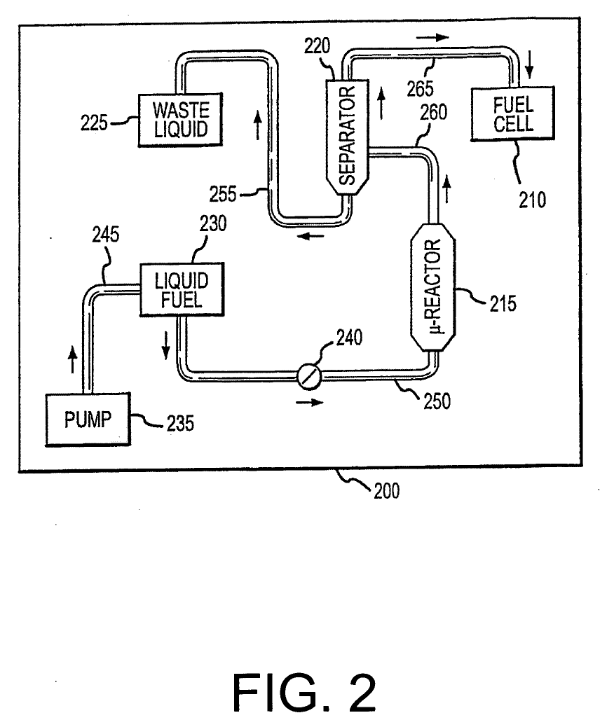

FIG. 2 generally depicts another exemplary embodiment in accordance with a representative aspect of the present invention. A substantially integrate micro-fuel cell device 200 generally comprises a fuel pump 235 for delivering hydraulic pressure through transport line 245 to expel liquid fuel 230 for introduction to catalytic micro-reactor 215 via fuel transport path 250. Optionally, a valve 240 may be provided in transport path 250 for controlling or otherwise managing the introduction of liquid fuel 230 to micro-reactor 215. The resulting liquid/gas fuel mixture is then introduced to separator 220 via transport path 260. Spent fuel is then directed to waste liquid reservoir 225 via transport path 255, while gaseous fuel is delivered to fuel cell 210 via transport path 265.

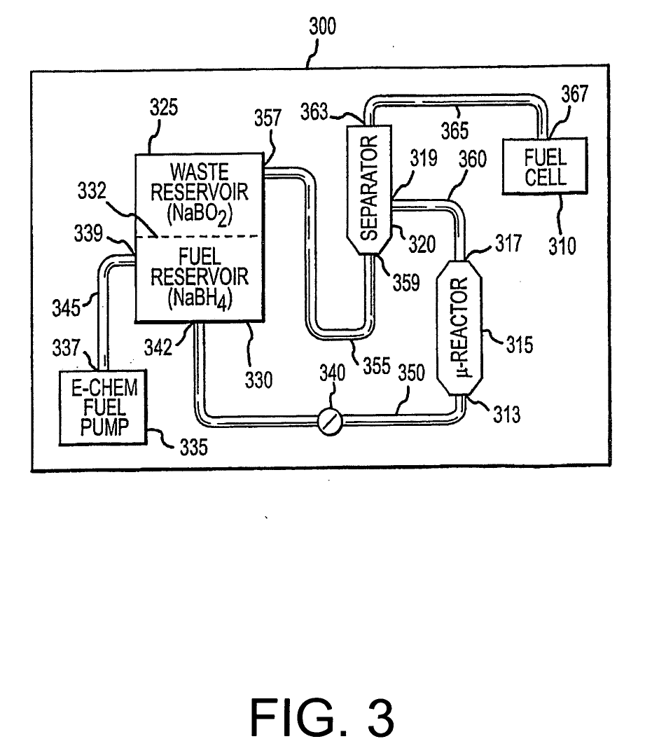

FIG. 3 generally depicts yet another exemplary embodiment in accordance with a representative aspect of the present invention. A substantially integrate micro-fuel cell device 300 generally comprises an electrochemical fuel pump 335 for delivering hydraulic pressure through transport line 345 along fuel pump outlet 337 thru fuel reservoir inlet 339 to expel liquid fuel 330 for introduction to catalytic micro-reactor 315 via fuel transport path 350 along reservoir outlet 342 thru micro-reactor inlet 313. Optionally, a valve 340 may be provided in transport path 350 for controlling or otherwise managing the introduction of liquid fuel 330 to micro-reactor 315. The resulting liquid/gas fuel mixture is then introduced to separator 320 via transport path 260 from micro-reactor outlet 317 thru separator inlet 319. Spent fuel is then directed to waste liquid reservoir 325 via transport path 355 from first separator outlet 359 to waste reservoir inlet 357, while gaseous fuel is delivered to fuel cell 310 via transport path 365 from second separator outlet 363 thru fuel cell inlet 367.

As generally shown in FIG. 3, fuel reservoir 330 may be optionally configured with a diaphragm, partition, membrane or bladder 332 for disposing spent liquid fuel in a region 325 at least partially separated from unprocessed liquid fuel 330 in such a fashion that as the volume of unprocessed liquid fuel 330 is depleted, the waste reservoir region 325 is enlarged to at least partially occupy a portion of the depleted volume formerly occupied by the unprocessed liquid fuel 330.

The disclosed fuel cell system is a miniature low-temperature, long-lived electrical power supply system for man portable applications that require up to about 1 W to greater than about 20 W of power. Catalytic room-temperature borohydride hydrolysis is accomplished in a plastic microfluidic micro-reactor and offers a low temperature process for generating hydrogen gas to supply hydrogen fuel to a fuel cell, the ultimate source of electric power in this device which is a hybrid of a fuel cell, a battery, a power conditioning subsystem and system control circuitry. Hydrogen gas may be used because it is a well-behaved anode reactant for a low temperature PEM fuel cell. The power supply system may be configured as a hybrid of a battery and a PEM fuel cell, since the battery may be suitably adapted to provide an acceptable power/time profile and system start up benefits while the fuel cell provides relatively long application lifetime. The fuel cell may be configured to enable the hybrid system to provide an energy density on the order of up to about 3 to more than about 10 times greater than is possible with any presently available conventional battery alone.

In an exemplary embodiment in accordance with one representative aspect of the present invention, plastic housed microfluidics are used to fabricate a miniature room temperature hydrogen gas generator. Hydrogen gas is liberated from, for example, a liquid alkaline aqueous sodium borohydride solution 330 by, for example, the following catalytic hydrolysis reaction:

$$Na B {H}_{4} + 2 {H}_{2} O {\to }^{{H}^{+} catalyst} 4 {H}_{2} + Na B {O}_{2}$$

An exemplary hydrogen storage solution suitable for use as the fuel can be an aqueous alkaline solution, such as a 1M sodium hydroxide having a pH of approximately 14, containing approximately 30 wt % sodium borohydride. In use, then the borohydride solution is flowed into micro channels containing a catalyst, such as ruthenium metal supported on aluminum, hydrogen can be catalytically generated by the hydrolysis of the sodium borohydride.

In an exemplary embodiment, the H⁺ catalyst 150 may be Ruthenium. The borohydride solution 330 generally allows safe, stable (on the order of up to about or more than 450 day half-life) and high energy-density hydrogen storage (on the order of up to about or more than 3000 Watt-hour/liter). FIG. 1 shows a block diagram of a more generalized gaseous fuel generator 100 and fuel cell 110 subsystem. In the case of a borohydride fueled hydrogen generator, after hydrolytic hydrogen gas generation, the hydrogen may be separated from the liquid waste borax (NaBO₂) solution by a liquid gas separator or membrane 155. In one aspect, a suitable gas liquid separating membrane can be the Celgard 4560. To this end, it will be appreciated that use of said membranes to separate the hydrogen gas from the liquid waste can provide orientation-independent gas-liquid separation allowing greater overall flexibility for the inventive fuel cell's use as a portable power supply.

The hydrogen gas may then be provided to the anode 125 of a polymer electrolyte membrane 130 (PEM) fuel cell, while waste liquid borax solution and water is channeled back 165 to a waste reservoir 325, 225, 145. In an exemplary embodiment, the waste reservoir 325, 145 may be provided as the volume that remains when the fuel reservoir 330, 140 becomes at least partially depleted. In such an embodiment, waste liquid borax solution and water may be channeled back 165 to fill the space that was originally occupied by the sodium borohydride hydrogen-storage solution 325.

Hydrogen fuel gas may be generated from liquid alkaline borohydride solution, for example, by passing the solution over solid supported Ru metal, or other suitable metals, to promote the heterogeneous catalytic hydrolysis of the alkaline borohydride. Alternatively, hydrogen fuel gas may be generated by adding acid to the solution thereby lowering the solution pH to effect homogeneous acid-catalyzed hydrolysis of borohydride.

In one aspect, the solid supported catalyst can comprise a packed bed of metal-supported catalyst particles. As stated above, the packed bed of supported catalyst particles can further comprise any suitable catalyst, or combination of catalysts, such as for example, a packed bed of solid supported Ruthenium metal on an alumina support, such as a gamma alumina support. To this end, an exemplary ruthenium catalyst bed can be prepared by soaking high surface area gamma alumina pellets in a 2 or 5 wt % RuCl₃ solution in deionized water for approximately 12 hours. The solution can then be decanted off and the resulting coated alumina pellets can be dried at room temperature before being dried in a tube furnace at 100° C. under helium.

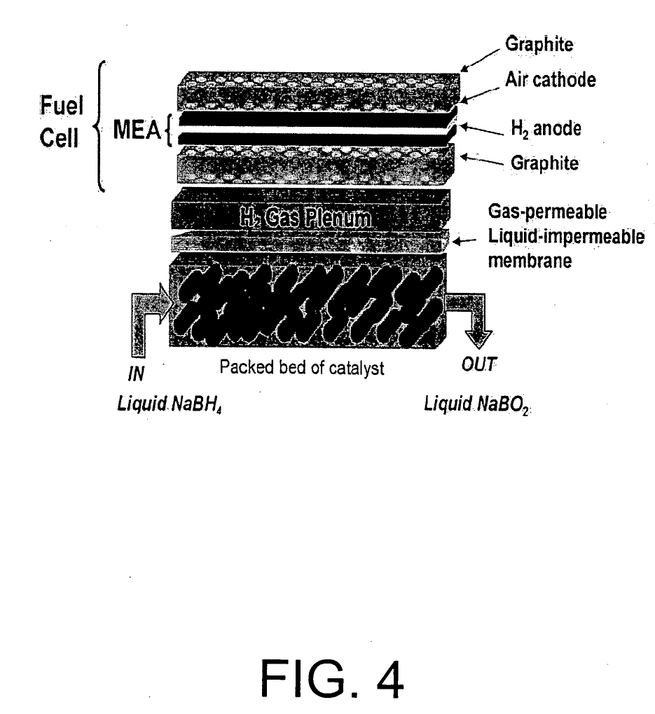

With reference to FIG. 4, a schematic diagram of an exemplary orientation-independent hydrogen-generator employing a gas/liquid separating membrane and a packed bed of catalyst particles is shown. The illustrated hydrogen generator is further mated with a fuel-cell. The fuel cell is comprised of a membrane electrode assembly (MEA) having a PEM sandwiched between a hydrogen anode and an oxygen or air cathode. The MEA is further housed within a moldable graphite current collecting plates.

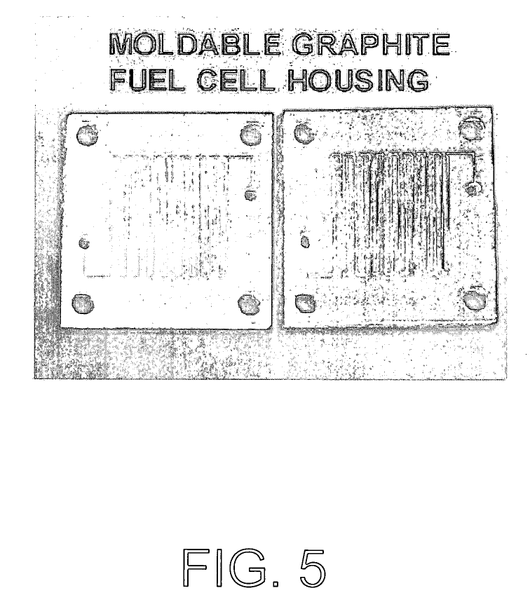

In one aspect, and as further shown in FIG. 5, exemplary graphite current collecting plates can have serpentine gas channels. To that end, one of the plates cam supply hydrogen gas through the serpentine flow field to the hydrogen anode and the other plate can supply oxygen through the serpentine flow field to the cathode.

In an alternative aspect, the solid supported catalyst can comprise a catalyst that is supported on one or more walls of a microfluidic channel reactor. For example, in one aspect, a catalytic hydrogen generating reactor can comprise a polymeric micro-pillar array supporting a Ruthenium catalyst. To this end, the mirco-pillar array catalyst support structure provides a relatively high surface area for the catalytic reaction.

It will be appreciated by one of ordinary skill in the art that a catalyst supported on a wall of a microfluidic channel reactor can provide the requisite catalyst surface are without impeding the flow of the liquid borohydride solution relative to typical flow characteristics exhibited by a packed bed of solid supported catalyst particles. Thus, a catalyst coated wall support structure can be used to reduce or eliminate the pressure drop that can occur across a micro-channel reactor comprised of a back bed of supported catalyst particles. Accordingly, a micro channel reactor comprising a wall coat supported catalyst can further provide the added flexibility to alter micro channel dimensions to, for example, optimize and/or reduce the pressure drop across the micro-channel reactor during flow of the liquid borohydride solution. By reducing the pressure drop that occurs across the micro-channel reactor the power needed to drive a fluid pump can similarly be reduced, thus improving the overall efficiency of the microfluidic fuel cell.

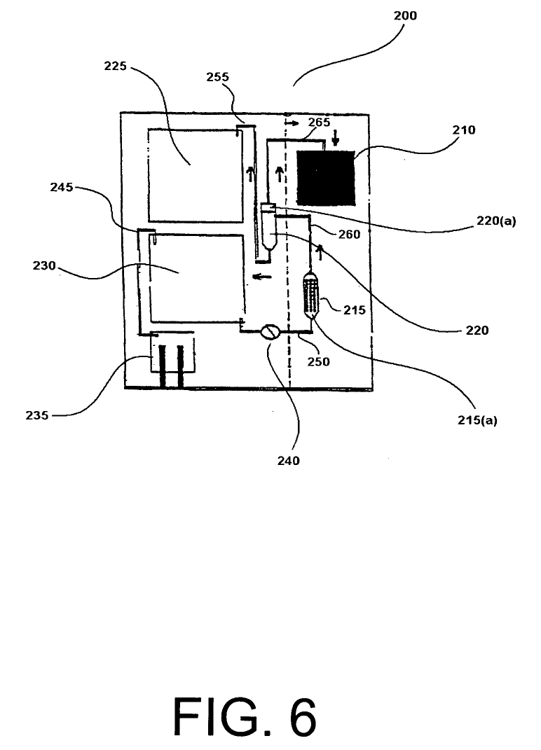

As shown in FIG. 6, a substantially integrate micro-fuel cell device 200 comprising an exemplary wall coated catalytic hydrogen generation reactor is shown. The micro fuel cell device generally comprises a fuel pump 235 for delivering hydraulic pressure through transport line 245 to expel liquid fuel 230 for introduction to catalytic micro-reactor 215 via fuel transport path 250. Optionally, a valve 240 may be provided in transport path 250 for controlling or otherwise managing the introduction of liquid fuel 230 to micro-reactor 215. The microreactor 215 is further comprised of a micro-pillar array 215(a) supporting a catalytic composition. The resulting liquid/gas fuel mixture is then introduced to separator 220 via transport path 260. Separator 220 further comprises a gas permeable membrane 220(a) to separate gaseous fuel from the spent liquid fuel. Spent fuel is then directed to waste liquid reservoir 225 via transport path 255, while gaseous fuel is delivered to fuel cell 210 via transport path 265.

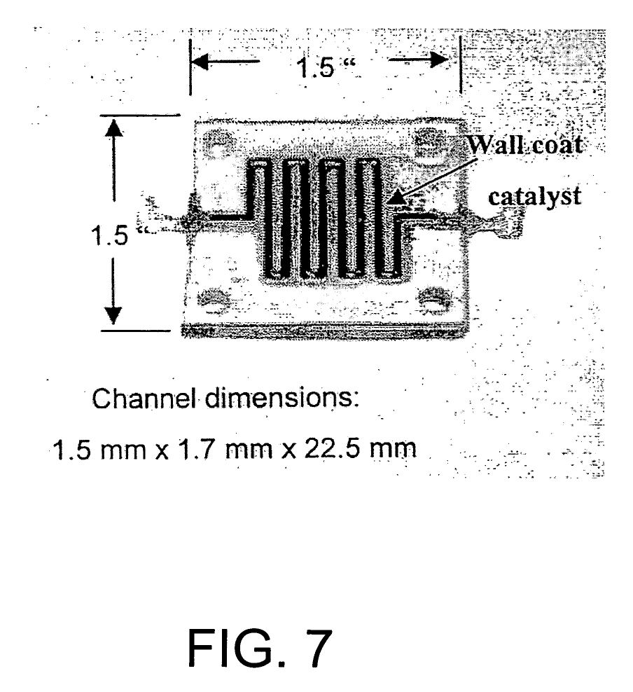

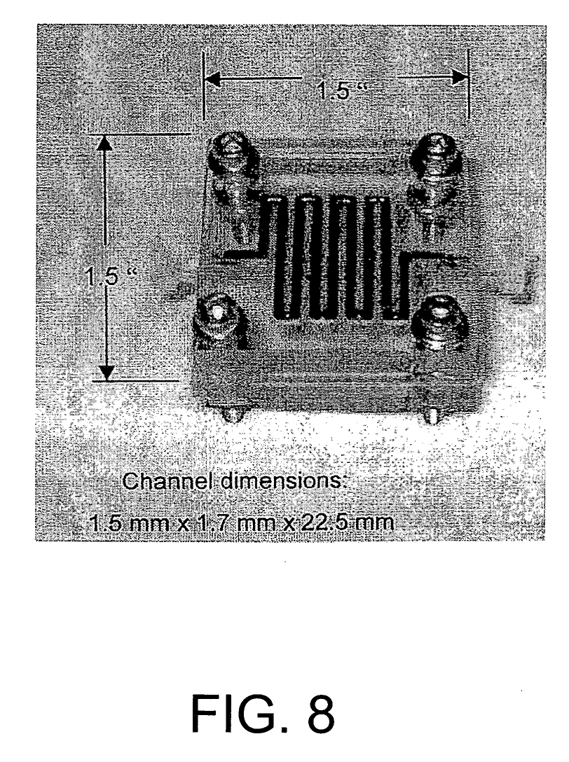

With reference to FIGS. 7 and 8, still another exemplary aspect of a wall coated catalytic hydrogen generation reactor is shown. More specifically, FIG. 7 illustrates an exemplary hydrogen micro reactor constructed and arranged to provide a serpentine fluid flow path. The wall of the serpentine shaped micro reactor is further coated with a suitable catalyst, such as for example Ruthenium. As shown, the exemplified micro-reactor is sized and shaped to provide, for example, a 1.5 inch by 1.5 inch square reactor forming a serpentine micro-channel having exemplary channel dimensions of approximately 1.5 mm×1.7 mm×22.5 mm. To that end, FIG. 8 further illustrates the micro-reactor of FIG. 7 integrated in a stacked arrangement with a liquid gas separator or membrane, such as the Celgard 4560 described above.

Conventional hydrogen and air-fed PEM fuel cells employ a Pt-catalyzed porous anode and cathode on opposite sides of a sheet of proton-conducting solid membrane electrolyte, like Nafion. With sulfonic acid membranes, like Nafion, water is needed for proton conduction, so water has to be supplied to the membrane either in the anode feed or from back diffusion of water made at the cathode. Liquid water can form over the anode surface, which would block the needed Knudsen diffusion of hydrogen into the anode gas feed pores. This blockage leads to low fuel cell efficiency and power. The present invention also anticipates, but does not require, novel PEM fuel cells using proton conducting membranes made from derivatives of C60 “buckyballs” or protic ionic salts, since such a C60 membrane or a protic ionic salt membrane generally need no water for proton conduction, which operates to greatly simplify water management, and as a consequence, would permit simple dead-ending of dry hydrogen to supply the anode. If the C60 is not used, a Nafion membrane may be used, however, liquid water would need to be removed from the anode surface and directed to the liquid waste storage region by using, for example, a hydrophilic liquid water-passing/gas-holding gas/liquid separator. This would generally operate to keep hydrogen freely flowing and diffusing into the anode.

Liquid-water can be separated from hydrogen gas using hydrophilic porous silicon membranes, which generally permit the passage of liquid water but holds back hydrogen gas. The cathode may have passive (i.e., stagnant air) or an active (i.e., forced air) feed. In one exemplary embodiment, any cathode water may be dumped into the environment; however, if it is desired, liquid water from the cathode may be captured and directed back, for example, to the waste reservoir in a scheme similar to that previously discussed for removing liquid water from the anode. This may be especially desirable for recharging the spent fuel solution to regenerate the borohydride fuel in accordance with the following:
NaBO₂+H₂O→NaBH₄+O₂

where water is the source of protons and electric or solar electric power drives the recharging reaction.

Ancillary subsystems, such as a liquid fuel storage/waste receptacle chamber 225, current collectors, valves 240, 340, fuel pumps 335, 235, air fans, dc-dc converters, system controllers, etc. may be employed to provide a substantially complete power supply system. For example, well-known heated paraffin valving and electrochemical pumping techniques may be employed. One-way piezo pumps with check valves may also be used for liquid pumping. This may be desirable as a practical system may be adapted to provide substantially direct control of H₂ generation by the electronic control of the frequency of liquid pumping.

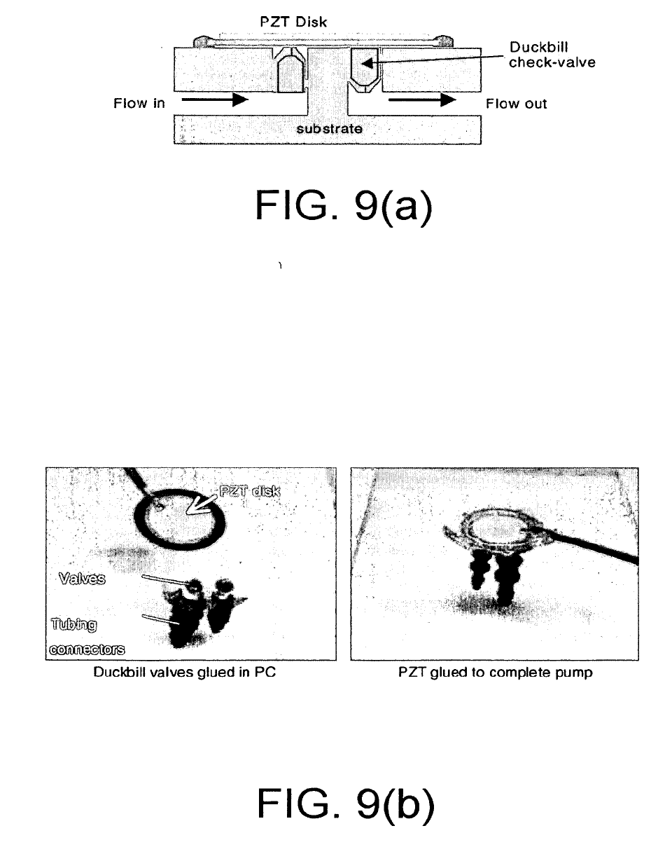

More specifically, Piezo pumps have been developed that can provide a relatively wide range of liquid flow rates ranging on a scale of, for example, from the microliter level to milliliter per minute, by controlling the piezo excitation voltage and frequency. The pumps can develop for example, a 5 psi pressure head, can be self0priming, gas-bubble tolerant, relatively low in cost, i.e., generally less than $1.00 USD, and relatively efficient, i.e., drawing relatively little power from a battery or fuel cell. To this end, FIG. 9(a) illustrates a schematic diagram of a piezo pump design showing features including a piezo element (PZT disk), check valve, and housing, which is typically comprised of plastic laminate. FIG. 9(b) shows an exemplary pump comprised of assembled components.

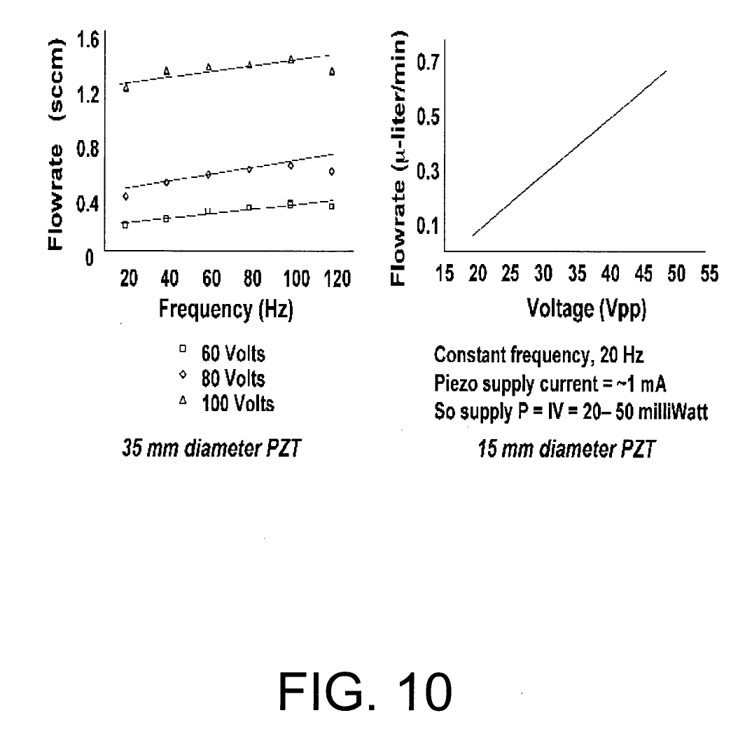

At a given voltage, a flow rate provided by a piezo pump will vary with frequency. To that end, a typical maximum frequency used can be approximately 100 Hz. Similarly, at a given frequency, the flow rate provided by the piezo pump will vary with voltage. To this end, a typical maximum voltage used can be approximately 100 V. Accordingly, FIG. 10 illustrates exemplary liquid flows that can be obtained using the exemplified piezo pumps under a variety of conditions. Specifically, the piezo pump having a 35 mm PZT disk and a duck bill check valve out puts a maximum one-way liquid flow of approximately 1.7 ml min⁻¹ of an exemplary 30% alkaline borohydride solution. This flow would generate approximately 1700 sccm H₂, of generally enough hydrogen to generate 120 watts of electrical power.

The pump can further be integrated with electronic controllers in the fuel cell system and in one aspect can draw a relatively low parasitic power, such as for example 10 mW for a pump that can supply a hydrogen fuel solution to a 1 W fuel cell, or in another example, approximately 0.5 W for a pump that can supply a hydrogen fuel solution to a 100 W fuel cell. Accordingly, these relatively low power piezo-pumps, when used in the inventive fuel cell system, can allow for controlled, self generated hydrogen flow from a reactor, through a gas liquid separating membrane, to a fuel anode. In still a further aspect, the pumps can also pump spent liquid product back to a bladder in a fuel storage reservoir. It will be appreciated that providing a controlled flow can ensure that no excess hydrogen builds up in the system during power generation.

The stack power density may be adapted to be on the order of about 100 W per liter, based on a membrane electrode assembly generating about 0.1 W to about 0.35 W per square centimeter at 0.7 V per cell. The system energy density may be adapted to provide on the order of about 1000 Watt-hour per liter, based on a fuel composition, for example, of 30% (wt) NaBH₄ and 4.3% (wt) NaOH and 67% (wt) water (2500 Wh/l). A system chemical-to-electrical conversion efficiency of about 50% may be observed allowing the hydrogen generator/fuel cell subsystem about 10% of the total volume (fuel plus system). 1 Liter of NaBH₄-30 solution has about 66 grams of hydrogen, or about 789 standard liters of hydrogen gas. Table 1 below, gives exemplary fluid flows needed to sustain exemplary electrical currents.

TABLE 1

| | Liquid Fuel Flow | | | |
|---|---|---|---|---|
| | (microliter min⁻¹ | Molar Flow | H₂ gas flow | P at 0.7 V |
| Current (A) | 30% NaBH₄ | (mole min⁻¹) | (sccm) | (W) |
| 0.1 | 1 | 3.1 E−05 | 0.7 | 0.07 |
| 1 | 10 | 3.1 E−04 | 7.0 | 0.7 |
| 2 | 20 | 6.2 E−04 | 14 | 1.4 |
| 10 | 100 | 3.1 E−03 | 70 | 7 |

The freezing point of borohydride-30 is about −13 F to about −36 F and the boiling point is about 120 C. The half-life at 70 F of the hydrogen storage solution is on the order of about 450 days. Accordingly, these characteristics afford a system that may be adapted to operate over a wide range of practical conditions desirable for portable power applications.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, “has”, “having”, “includes”, “including” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A hybrid, regenerative energy device comprising:
a microfluidic assembly comprising a microfluidic containment volume, said microfluidic containment volume suitably adapted to contain a mixture of at least one of a solid, a gas and a liquid fluid reagent;
a substrate for supporting a catalytic composition; said catalytic composition suitably adapted to promote catalytic hydrolysis of a substantially liquid-borne fuel precursor to generate a gaseous fuel;
a liquid/gas separator for at least partially partitioning a gaseous component and a liquid component;
a fuel cell comprising an anode and a cathode; and
electrical connections coupled to said fuel cell component for at least one of applying, exploiting, collecting and storing an energy potential for generating power.

2. The device of claim 1, wherein said power is generated at substantially ambient temperature.

3. The device of claim 1, wherein said generated power is between 0.1 and 100 Watts.

4. The device of claim 3, wherein said generated power is between 1 and 10 Watts.

5. The device of claim 1, wherein at least one of:
said gaseous fuel is hydrogen;
said liquid fuel precursor is an alkaline aqueous NaBH₄ mixture;
said liquid waste/byproduct is an aqueous NaBO₂ mixture; and
said supporting substrate comprises high surface area alumina and said catalytic composition comprises Ru.

6. The device of claim 1, wherein at least one of:
said fuel cell comprises a PEM;
said gas/liquid separator comprises a plurality of apertures with dimensions on the order of up to about 1 nm;
said microfluidic assembly comprises a polymeric material; and
said catalytic support surface comprises at least one of a laminar flow field, a linear flow field, a non-linear flow field, a curvilinear flow field and a convoluted flow field.

7. The device of claim 1, wherein said gaseous compound comprises at least one of CO₂, CH₃OH, CHOOH, H₂CO, H₂, O₂, H₂O and H₂O₂.

8. The device of claim 1, wherein said gas/liquid separator comprises at least one of a polymer membrane, a porous ceramic, a porous silicon matrix, a stainless steel grit and fritted glass.

9. The device of claim 8, wherein said polymer membrane comprises at least one of Nafion®, Teflon®, Zitex® A and Zitex® G.

10. The device of claim 8, wherein said membrane is substantially self-gasketing.

11. The device of claim 8, further comprising means for disposing said barrier to effectively seal said membrane comprises at least one of a gasket,
a clamp, a press-fit clip, a heat-melted seal, a vacuum seal, a magnetic seal;
a screw, a bolt, a nut, a rivet, a pin, an adhesive, solder, an aligning element,
a peripheral skirt, a mesh and a screen cap.

12. The device of claim 1, wherein said device comprises at least one of a substantially unitary article of manufacture and a substantially integrated article of manufacture.

13. The device of claim 1, wherein said supporting substrate comprises at least a portion of a micro-channel reactor wall.

14. The device of claim 13, wherein said supporting substrate comprise a polymeric micro-pillar array.

15. The device of claim 13, wherein said catalytic composition comprises Ru.

16. A method for providing a hybrid, regenerative energy power source, said method comprising the steps of:
providing a microfluidic assembly comprising a microfluidic containment volume, said microfluidic containment volume suitably adapted to contain a mixture of at least one of a solid, a gas and a liquid fluid reagent;
providing a substrate suitably adapted to support a catalytic composition; said catalytic composition suitably adapted to promote catalytic hydrolysis of a substantially liquid-borne fuel precursor to generate a gaseous fuel;
providing a liquid/gas separator suitably adapted to at least partially partition a gaseous component and a liquid component;
providing a fuel cell comprising an anode and a cathode; and
providing electrical connections coupled to said fuel cell component for at least one of applying, exploiting, collecting and storing an energy potential for generating power.

17. The method of claim 16, wherein said power is generated at substantially ambient temperature.

18. The method of claim 16, wherein said generated power is between 0.1 and 100 Watts.

19. The method of claim 18 wherein said generated power is between 1 and 10 Watts.

20. The method of claim 16, wherein at least one of:
said gaseous fuel is hydrogen;
said liquid fuel precursor is an aqueous NaBH₄ mixture;
said liquid waste/byproduct is an aqueous NaBO₂ mixture;
said supporting substrate comprises high surface area alumina; and
said catalytic composition comprises Ru.

21. The method of claim 16, wherein at least one of:
said fuel cell comprises a PEM;
said gas/liquid separator comprises a plurality of apertures with dimensions on the order of up to about 1 nm;
said microfluidic assembly comprises a polymeric material; and
said catalytic support surface comprises at least one of a laminar flow field, a linear flow field, a non-linear flow field, a curvilinear flow field and a convoluted flow field.

22. The method of claim 16, wherein said gaseous compound comprises at least one of CO₂, CH₃OH, CHOOH, H₂CO, H₂, O₂, H₂O and H₂O₂.

23. The method of claim 16, wherein at least one of:
said gas/liquid separator comprises at least one of a polymer membrane, a porous ceramic, a porous silicon matrix, a stainless steel grit and fritted glass;
said polymer membrane comprises at least one of Nafion®, Teflon®, Zitex® A and Zitex® G; and
said membrane is substantially self-gasketing.

24. The method of claim 16, wherein said supporting substrate comprises at least a portion of a micro-channel reactor wall.

25. The method of claim 24, wherein said supporting substrate comprise a polymeric micro-pillar array.

26. The method of claim 24, wherein said catalytic composition comprises Ruthenium.

27. The method of claim 24, wherein said supporting substrate does not substantially impede the flow of the substantially liquid borne fuel precursor.
